(19) United States
(12) Patent Application Publication
(10) Pub. No.: US 2004/0141641 A1
(43) Pub. Date: Jul. 22, 2004

(54) Seed image analyzer

(76) Inventors: Miller Baird McDonald JR., Dublin, OH (US); Timothy Daoust, Huntington, WV (US); Kikuo Fujimura, Palo Alto, CA (US); Andrew F. Evans, Westerville, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/348,417

(22) Filed: Jan. 21, 2003

(51) Int. Cl. G06K 9/62; G06K 9/00

(52) U.S. Cl. 382/159; 382/141

(57) ABSTRACT

Computer imaging systems are employed to image, analyze, classify and/or sort seeds and other agricultural items. The systems may be local and/or remote, serial and/or parallel processing, employing various classification schemes including Fisher Linear Discriminant processing and various hardware including a color, digital scanner.

It is emphasized that this abstract is provided to comply with the rules requiring an abstract that will allow a searcher or other reader to quickly ascertain the subject matter of the application. It is submitted with the understanding that it will not be used to interpret or limit the scope or meaning of the claims. 37 CFR 1.72(b).

### TECHNICAL FIELD

The systems, methods, application programming interfaces (API), graphical user interfaces (GUI), data packets, and computer readable media described herein relate generally to agriculture and more particularly to imaging, identifying, purity analyzing, and sorting seeds.

### BACKGROUND

Seed analysts in laboratories, companies, farms, and so on routinely perform purity analysis. In fact, purity analysis is required by federal law since a vendor must provide information on a seed label describing the quality of the seed lot to customers. A traditional four-part purity analysis required by the AOSA (2000) reports the percentage pure seed, other crop, inert matter, and weed seed within a sample. High quality seed samples generally contain greater than 95% pure seed and a small percentage of other contaminants.

Traditional purity analysis is a process in which a seed analyst manually sorts and weighs the desired species, unwanted seeds, and inert matter within a sample. Seed analysts conduct conventional purity tests by placing a representative sample on a clean hard surface known as a purity board, drawing a portion of the sample toward the bottom of the board and categorizing seeds or particles as they pass through the field of view. The pure seed is placed into a container at the front of the purity board and inert matter, weed seeds, and other crop seeds placed on the side(s) of the board. Once the pure seed has been separated, the inert material, other crop and weed seeds are placed in separate containers for final examination. The final classification is often made using a magnifying lens or dissecting microscope. The speed of the test can vary widely based on the experience of the analyst and the quality and type of sample. An experienced analyst working with a clean sample may be able to conduct a purity analysis on 100 g of moderately sized seeds in approximately fifteen minutes.

But purity analysis is only one area in which seeds are analyzed and/or sorted. Farmers typically analyze seed they purchase, law enforcement officials analyze seeds obtained to determine the (il)legality of the seed, and customs officials analyze seeds that people may wish to bring into the country. Conventionally, this analysis has been performed manually.

### SUMMARY

The following presents a simplified summary of methods, systems, computer readable media and so on for establishing classification data, classifying, identifying, purity analyzing and/or sorting seeds to facilitate providing a basic understanding of these items. This summary is not an extensive overview and is not intended to identify key or critical elements of the methods, systems, computer readable media, and so on or to delineate the scope of these items. This summary provides a conceptual introduction in a simplified form as a prelude to the more detailed description that is presented later.

In one example, an image processing computer application was developed to collect measurements and/or statistics from seed images. The measurements and/or statistics were then used in automated seed classification and/or sorting. The example employed a scanner and a personal computer, although it is to be appreciated that other imaging and computer components can be employed. A digital image of seeds was acquired, then a trainable computer component located seed images within the digitized image. The trainable computer component took seed measurements (e.g., width, height, area, perimeter, color, texture). The trained computer component then developed seed classifications, classified seeds in an image, and reported the results. One example system can be configured and trained up by persons without knowledge of artificial intelligence techniques. Another example system can be configured to sort the seeds.

Certain illustrative example methods, systems, computer readable media and so on are described herein in connection with the following description and the annexed drawings. These examples are indicative, however, of but a few of the various ways in which the principles of the methods, systems, computer readable media and so on may be employed and thus are intended to be inclusive of equivalents. Other advantages and novel features may become apparent from the following detailed description when considered in conjunction with the drawings.

### BRIEF DESCRIPTION OF THE DRAWINGS

FIG. 1 is a schematic block diagram of a seed analyzing system.

FIG. 2 is a schematic block diagram of a distributed seed analyzing system.

FIG. 3 is a schematic block diagram of a training and analyzing system.

FIG. 4 is a schematic block diagram of an analyzing and sorting system.

FIG. 5 is a flowchart of an example method for building a seed analysis database.

FIG. 6 is a flowchart of an example method for classifying seeds.

FIG. 7 is a flowchart of an example method for classifying seeds.

FIG. 8 is a flowchart of an example method for sorting seeds.

FIG. 9 is a schematic block diagram of an example computing environment with which the example systems and methods may interact or on which they may be implemented.

FIG. 10 illustrates an API.

FIG. 11 illustrates various stages in image processing associating with seed analyzing.

FIG. 12 illustrates a seed.

FIG. 13 illustrates a Fisher Linear Discriminant projection.

FIG. 14 illustrates an image of seeds.

FIG. 15 illustrates a set of seed images.

FIG. 16 illustrates a data packet.

FIG. 17 illustrates sub-fields in a data packet.

### DETAILED DESCRIPTION

Example systems, methods, computer media, and so on are now described with reference to the drawings, where like reference numerals are used to refer to like elements throughout. In the following description for purposes of explanation, numerous specific details are set forth in order to facilitate thoroughly understanding the methods, systems and computer readable media. It may be evident, however, that the methods, systems and computer readable media can be practiced without these specific details. In other instances, well-known structures and devices are shown in block diagram form in order to simplify description.

Lexicon

As used in this application, the term “computer component” refers to a computer-related entity, either hardware, firmware, software, a combination thereof, or software in execution. For example, a computer component can be, but is not limited to being, a process running on a processor, a processor, an object, an executable, a thread of execution, a program and a computer. By way of illustration, both an application running on a server and the server can be computer components. One or more computer components can reside within a process and/or thread of execution and a computer component can be localized on one computer and/or distributed between two or more computers.

“Computer communications”, as used herein, refers to a communication between two or more computers and can be, for example, a network transfer, a file transfer, an applet transfer, an email, a hypertext transfer protocol (HTTP) message, a datagram, an object transfer, a binary large object (BLOB) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, and so on.

“Logic”, as used herein, includes but is not limited to hardware, firmware, software and/or combinations of each to perform a function(s) or an action(s). For example, based on a desired application or needs, logic may include a software controlled microprocessor, discrete logic such as an application specific integrated circuit (ASIC), or other programmed logic device. Logic may also be fully embodied as software.

“Signal”, as used herein, includes but is not limited to one or more electrical or optical signals, analog or digital, one or more computer instructions, a bit or bit stream, or the like.

“Software”, as used herein, includes but is not limited to, one or more computer readable and/or executable instructions that cause a computer or other electronic device to perform functions, actions and/or behave in a desired manner. The instructions may be embodied in various forms like routines, algorithms, modules, methods, threads, and/or programs. Software may also be implemented in a variety of executable and/or loadable forms including, but not limited to, a stand-alone program, a function call (local and/or remote), a servelet, an applet, instructions stored in a memory, part of an operating system or browser, and the like. It is to be appreciated that the computer readable and/or executable instructions can be located in one computer component and/or distributed between two or more communicating, co-operating, and/or parallel processing computer components and thus can be loaded and/or executed in serial, parallel, massively parallel and other manners. It will be appreciated by one of ordinary skill in the art that the form of software may be dependent on, for example, requirements of a desired application, the environment in which it runs, and/or the desires of a designer/programmer or the like.

An “operable connection” (or a connection by which entities are “operably connected”) is one in which signals and/or actual communication flow and/or logical communication flow may be sent and/or received. Usually, an operable connection includes a physical interface, an electrical interface, and/or a data interface, but it is to be noted that an operable connection may consist of differing combinations of these or other types of connections sufficient to allow operable control.

“Data store”, as used herein, refers to a physical and/or logical entity that can store data. A data store may be, for example, a database, a table, a file, a list, a queue, a heap, and so on. A data store may reside in one logical and/or physical entity and/or may be distributed between two or more logical and/or physical entities.

“Measurement” as used herein, refers to an extent, magnitude, size, capacity, amount, dimension, characteristic or quantity ascertained by measuring. Example measurements are provided, but such examples are not intended to limit the scope of measurements the systems and methods described herein can employ.

To the extent that the term “includes” is employed in the detailed description or the claims, it is intended to be inclusive in a manner similar to the term “comprising” as that term is interpreted when employed as a transitional word in a claim.

To the extent that the term “or” is employed in the claims (e.g., A or B) it is intended to mean “A or B or both”. When the author intends to indicate “only A or B but not both”, then the author will employ the term “A or B but not both”. Thus, use of the term “or” in the claims is the inclusive, and not the exclusive, use. See BRYAN A. GARNER, A DICTIONARY OF MODERN LEGAL USAGE 624 (2d Ed. 1995).

Description

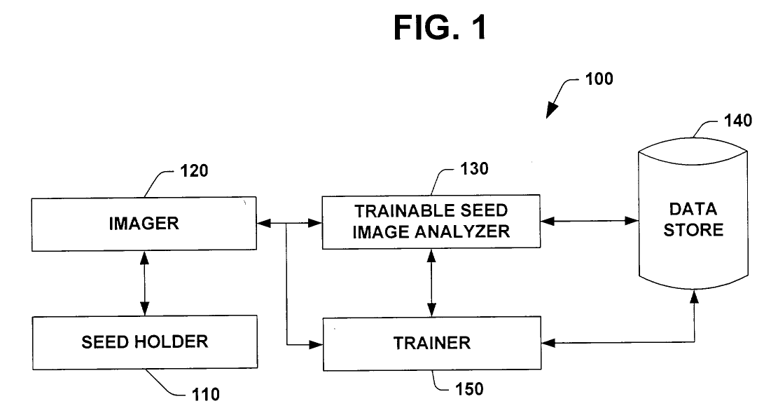

Turning now to FIG. 1, an example system 100 for imaging, identifying, (re)establishing classifications, and purity analyzing seeds is illustrated. The system 100 includes a seed holder 110, an imager 120, a trainable seed image analyzer 130, a data store 140, and a trainer 150. It is to be appreciated that this is but one example arrangement of components for a computer implemented system for classifying a seed. In one example, the system 100 may receive digital images from an external imaging system, and thus the system would include the trainable seed image analyzer 130, the data store 140 and the trainer 150.

The seed holder 110 holds seeds in a manner that facilitates acquiring digital images from which features can be extracted and from which measurements can be taken which in turn facilitate classifying seeds. In one example, the seed holder 110 is a box into which seeds can be placed and in which the type and amount of light can be controlled. The box may include a pull-out drawer that has a high contrast color relative to the seeds that are placed in the pull-out drawer to facilitate improving contrast in digital images acquired by the imager 120. In one example, the pull-out drawer may be lineable with sheets of paper with different high contrast colors that facilitate acquiring a digital image of the seeds placed in the seed holder 110. By way of illustration, for dark seeds, the seed holder 110 may be configured with white paper onto which the seeds can be placed. In another example, the inside of the seed holder 110 may have adaptive panels that can be programmatically and/or electronically configured to facilitate improving contrast and/or color recognition in digital images. By way of illustration, digital images of a seed sample that is primarily green may benefit from having the seeds imaged against a background of red. Thus, the seed holder 110 panels may be programmed to be red for certain seeds. Similarly, the seed holder 110 may have the ability to introduce light of various colors into the seed holder 110 before a digital image is acquired. Thus, the imager 120 may be able to acquire digital images with improved contrast, and other image acquisition parameters.

The ability of the seed holder 110 to adapt to various seeds facilitates acquiring digital images from which features can be extracted and from which measurements can be taken for a wider variety of seeds than is conventionally possible. This facility contributes to the overall ability of the system 100 to process a variety of seeds, rather than being implemented for a single seed analyzing problem or a small set of seed analyzing problems.

The system 100 includes a trainable seed image analyzer 130 that receives a digital seed image and that can be selectively controlled to relate a seed image to a seed classification, to update a seed classification, and/or to perform a purity analysis test. The training can be supervised by a trainer computer component. To understand how the trainable seed image analyzer 130 works, first examine an example seed classification. A seed classification, which may be stored in a data store 140, can include a classification identifier (e.g. name, number), a set of measurements associated with the seed classification, and one or more subsets of measurements that are employed in distinguishing a seed image associated with one seed classification from another seed classification. It is to be appreciated that a seed classification may be part of a hierarchy of seed classifications. Thus, the subset of measurements may be employed to navigate within such a hierarchy.

The trainable seed image analyzer 130 can, in one example, update a seed classification by updating the set of measurements associated with a seed classification. For example, the trainable seed image analyzer 130 can add measurements to the set, remove measurements from the set, adjust valid ranges for measurements in the set, and so on. Similarly, the trainable seed image analyzer 130 can, in one example, update a seed classification by updating the one or more subsets of measurements related to distinguishing seed classifications. By way of illustration, a first seed classification may be distinguishable from a second seed classification by color (e.g., all X are red, all Y are blue) while size and shape are poor distinguishers (e.g., both red and blue seeds have same size and shape). Thus, the seed classification may include a subset of measurements that are employed for distinguishing between the first and second seed classification. When the trainable seed image analyzer 130 determines that a seed sample image contains seeds of those two classifications, that subset of measurements may then be subsequently employed in distinguishing the seeds. By way of further illustration, the first seed classification may be distinguishable from a third seed classification by texture (e.g. all X have large spines, all Z are very smooth), while size and color are poor distinguishers. Again, the trainable seed image analyzer 130 and/or trainer 150 may recognize the distinguishing measurements and establish the subset of measurements in the seed classification for the seed types. Then, when a seed sample is encountered that includes these two seed types, the trainable seed image analyzer 130 may employ that subset of measurements to facilitate distinguishing the seeds in the sample.

Thus, the trainable image analyzer 130 is trainable to recognize distinguishing measurements and to update seed classifications based on recognizing distinguishing measurements. Furthermore, the trainable image analyzer 130 is trainable to select an appropriate subset of measurements for distinguishing seeds in, for example, a purity analysis test.

To facilitate recognizing the distinguishing measurements, the trainable seed image analyzer analyzes digital seed images produced by the imager 120. The imager 120 can be, for example, a color, digital scanner that produces a digital image of seeds in the seed holder 110. In one example, the imager 120 and the seed holder 110 can be incorporated into the same apparatus. By way of illustration, the seed holder 110 may include a digital scanner onto which seeds can be placed and imaged. For example, the scanner may have a top glass surface on which the seeds are imaged.

By way of further illustration, a seed holder 110 that has a pull-out drawer may have an inverted digital, color scanner attached to the top of the seed holder 110 so that a color digital image of seeds placed into the seed holder 110 can be acquired. While the imager 120 is preferably a scanner, it is to be appreciated that other digital image acquiring systems including, but not limited to, a digital still camera and a digital video camera can be employed. Furthermore, the imager 120 may include one or more imagers. For example, the seed holder 110 may have a first scanner incorporated into its lid, a second scanner incorporated into its back side and a third scanner incorporated into a side perpendicular to the back side. Thus, multi-dimensional images of seeds in the seed holder 110 can be acquired by the image acquiring system 120. Alternatively and/or additionally, a single imager may have a field of view and/or depth of focus that facilitate acquiring three dimensional images.

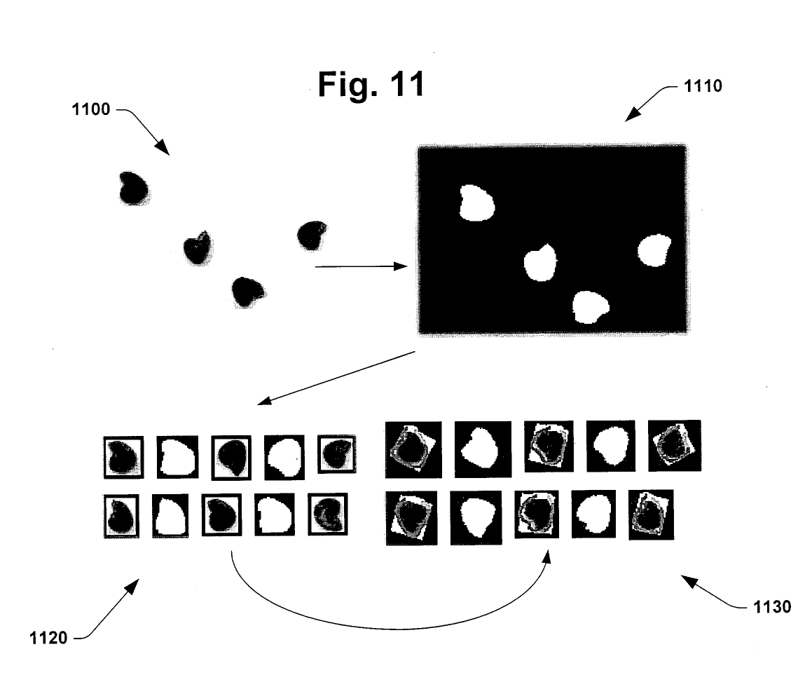

The digital images produced by the imager 120 are analyzed by the trainable seed image analyzer 130 and/or a trainer 150. One way in which the images are analyzed is by taking measurements from the images. For example, an image may have components representing numerous seeds. Measurements for each element can be made to facilitate classifying seeds, relating a seed image to a seed classification, performing a purity analysis test, sorting seeds, and so on. Image pre-processing that facilitates acquiring the measurements is discussed later in connection with FIGS. 11, 14 and 15. While several example measurements are described herein, these example measurements are illustrative and one skilled in the art will appreciate that other measurements can also be employed.

The measurements can include seed width. In one example, width is measured by locating the left and right most pixels of the seed within an isolated rotated image pattern that holds a seed representation. The distance between these two pixels is recorded as the seed width. The measurements can also include the seed height. Height is measured in a similar manner as width, but uses the top and bottom most pixels within the rotated image. The measurements can also include a computed measurement like width to height ratio. In one example, this ratio is computed as width/height. Because of major axis detection and rotation (discussed later in connection with FIGS. 11, 14 and 15), the value is usually less than 1. The measurements can also include depth. For example, if the width was the x dimension, and the height was the z dimension, then the depth could be the y dimension. Thus, the trainable image seed analyzer 130 can also produce a width to height to depth ratio, and other such variations.

The measurements can also include perimeter. In one example, perimeter is measured using the outside border of the seed in a two-color image that distinguishes the foreground from background. Chain coding, a technique known to those skilled in the art of computer image processing, can locate and store the pixels forming the seed border. Once the border pixels have been located, the total distance around the object is determined in pixels. In one example, adjacent pixels along the perimeter are assigned a distance of 1 pixel and diagonally touching pixels are assigned a distance of 1.414 pixels.

The measurements can also include area. In one example, an area measurement is taken by counting the number of pixels in the foreground in the image region representing the seed. This measurement is facilitated by the improved contrast available in the seed holder 110 and/or imager 120. In one example, chain coding of the perimeter and properties of line integrals, techniques known to those skilled in the art of computer vision systems, were used to compute the area.

The measurements can also relate to color. In one example, color in computer images is described by three values that indicate the intensity of the red, green, and blue components. Since computer information is discrete, the intensity is generally reported as a number that varies between 0 and 255, which facilitates processing approximately 16.7 million different colors. In one set of color measurements, the average values of the red, green, and blue pixel intensities were found for the pixels identified within the seed boundaries. These values described the overall color of the object, that is, the color perceived if the seed image was viewed from a long distance. Again, accurate color measurements are enhanced by the color adaptive properties of the seed holder 110 and/or imager 120.

The measurements can also include hue, saturation, and intensity measurements. These measurements may also be enhanced the color adaptive properties of a seed holder 110 and/or imager 120. Although the average red, green, and blue values describe the overall color of the object, the color values may benefit from being viewed in context with hue, saturation, and intensity measurements, rather than being examined in isolation. By way of illustration, the numerical difference between a dark green pixel and a light green pixel could be greater than the difference between a bright yellow pixel and a bright blue pixel. Thus, hue, saturation and intensity are measured. Hue, saturation, and intensity describe colors with a system closer to human perception of light. Hue quantifies what humans describe as red, green, blue, and so on. Intensity is a measure of the brightness of a pixel (e.g., how close the pixel is to white) and saturation is a measure of how dominant the pure hue is in the color.

The measurements may also relate to the convex hull area and perimeter of a seed. Seeds often have a concave shape, which provides a criteria useful for determining a seed classification. A related measurement, the convex hull area, facilitates analyzing the concavity and/or shape (e.g., spinyness) of a seed. In one example, the convex hull of a seed is the smallest convex shape containing the entire seed, and the convex hull is calculated using the list of pixels belonging to the perimeter of the seed. The area and perimeter of the convex hull are then measured. The measurements may, therefore, also include area and perimeter ratios. The convex hull area compared to the actual area of the seed indicates if the seed has a rough surface or spines. The convex hull perimeter compared to the perimeter provides similar information.

The measurements may also include an extent-fill measurement. Extent-fill indicates how closely the seed shape resembles a rectangle (computed as area/width*height). This feature facilitates recognizing elliptical and circular shapes. For elliptical and circular seeds, the area will be approximately π*(width/2)*(height/2) pixels.

The measurements can be direct (e.g. height, width) and/or ratios (e.g., height/width). While example ratios are described above, it is to be appreciated that ratios of forms like:

jx^{p}/kπ^{g}y^{q}

where x and y are direct measurements, j and k are integers and p, g, and q are real numbers, can be employed.

The measurements can also include measurements related to texture. In one example, texture is a measure of image regularity, smoothness and coarseness. In another example, texture is measured by measurements including, but not limited to, coarseness, contrast, directionality, line likeness, regularity, and roughness. In another example, texture is measured by measurements related to autoregressive and random field texture models. In another example, texture is measured by measurements related to coefficients of a discrete Fourier transform (DFT) while in another example texture is measured by measurements related to a two dimensional Gabor function.

Thus, the trainer 150 and the trainable seed image analyzer 130 have a set of measurements from which they can learn how to distinguish seed classifications. In one example, all the available measurements are analyzed when identifying the distinguishing measurements. In another example, one or more of the measurements are examined. In yet another example, measurements are analyzed individually in turn and then in a variety of subsets, after which rankings occur by which less relevant measurements for certain distinguishing tasks are identified. Then, further refinement of the distinguishing occurs. In one example where the trainer 150 is software with interactive features, individual measurements and/or sets of measurements can be interactively selected substantially in real time. This facilitates training up the trainable seed image analyzer.

That the trainable seed image analyzer 130 can automatically learn, under the control of the trainer 150, to make such distinctions makes the system useable for a wide variety of seeds and applications rather than conventional single use systems. For example, rather than a custom designed system appropriate for distinguishing two weed seeds from six very homogenous wheat seeds, the system 100 can be employed in a generic purity analysis system where there is no a priori knowledge about the target seed(s) and/or the likely contaminants. This makes the system 100 more applicable to purity analysis, where contaminants may not be known beforehand.

In one example, the trainable seed image analyzer 130 includes a computer component that can perform Fisher Linear Discriminant (FLD) processing to facilitate identifying distinguishing measurements. In another example, the trainable seed image analyzer 130 includes a computer component that can perform neural network processing to facilitate identifying distinguishing measurements. In yet another example, the trainable seed image analyzer 130 includes a computer component that can perform nearest neighbor classification to facilitate identifying distinguishing measurements. Thus, along with identifier data, a set of measurement data and subsets of relational/distinguishing measurements, a seed classification may also include data concerning the type of processing (e.g. FLD, neural network, nearest neighbor) to employ when performing seed classifications, purity analysis and/or sorting. Which processing to select can be learned by the trainable seed image analyzer 130 and then subsequently employed when analyzing a digital image of a seed sample. Again, the ability to, substantially in real time, select not only which measurements to employ to facilitate classifying, distinguishing, and/or sorting seeds, but also the ability to, substantially in real time, select the distinguishing algorithm(s) to apply, makes the system 100 applicable to a wider variety of seeds and applications than is conventionally possible. In another example where the system 100 demonstrates interactive actions, the processing to select can be chosen by the trainer 150 and/or an external process and/or human to facilitate training up the trainable seed image analyzer.

The trainer 150 can be a computer component that adjusts the trainable seed image analyzer 130 (e.g., updates connection weights in a neural network, selects features for FLD processing). Trainer 150 supervises the machine learning of the trainable seed image analyzer 130. The trainer 150 may present a graphical user interface (GUI) (not illustrated) in training up the trainable seed image analyzer to facilitate human interaction with the trainer 150 and/or trainable seed image analyzer 130. The GUI may display choices concerning actions associated with training the trainable image analyzer, and when a choice is made, an action is taken.

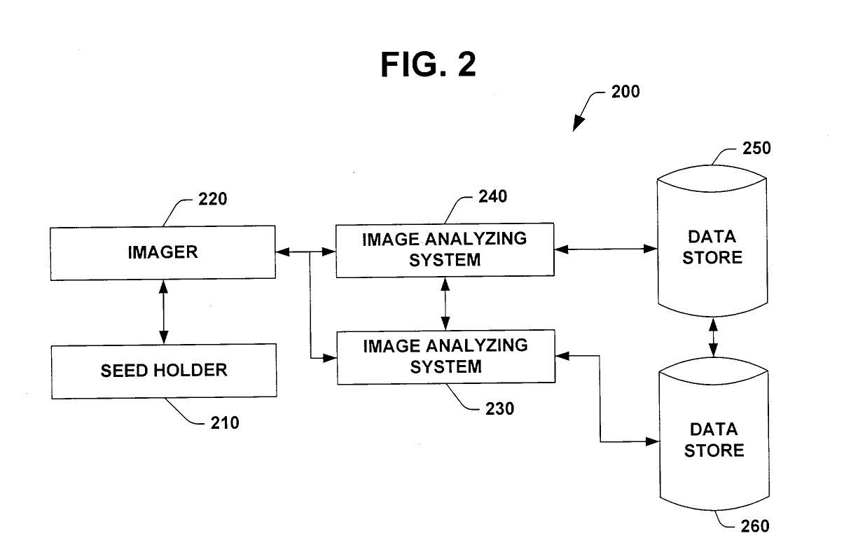

FIG. 2 illustrates an example distributed seed analyzing system 200. The system 200 includes two or more image analyzing systems (e.g., 230, 240). An example image analyzing system can include, for example, a trainable seed image analyzer and a trainer. Furthermore, an image analyzing system may include a trained up trainable seed image analyzer and no trainer. While two image analyzing systems are illustrated, it is to be appreciated that a greater number of image analyzing systems can participate in the distributed system 200. Similarly, while two data stores (e.g., 250, 260) are illustrated in FIG. 2 it is to be appreciated that a greater number of data stores can be employed with system 200.

The system 200 is a distributed system. Thus, some aspects of seed image analyzing can reside in a first image analyzing system (e.g. 240) while other exclusive and/or overlapping aspects of seed image analyzing can reside in one or more second image analyzing systems (e.g. 250). By way of illustration, a first image analyzing system may have been trained up with seed samples made up of various grasses and their related weeds. A second image analyzing system may have been trained up with seed samples made up of various legumes and their related weeds. Thus, when an imager 220 presents a digital image of a seed for classification or a purity analysis test, the components of the distributed system 200 may communicate and cooperate to determine which, if any, of the distributed image analyzing systems will process the image. By way of further illustration, an imager 220 may acquire a number of seed images. To facilitate more rapid training, and subsequently more rapid analysis of the images, the images may be distributed to various components within the system 200. Thus, a rapid response seed analysis system can be trained up to deal with newly discovered or encountered seeds. Furthermore, the system can be distributed between locations making it less susceptible to system failure due to shutdown at one location. For example, in a biological warfare situation (e.g., weapons inspectors) where heretofore unencountered seeds are encountered, the system 200 can be quickly trained up to classify seeds and to deposit the information and processing in multiple processors and/or data stores. In a more typical situation, an agribusiness may have multiple locations (e.g., wheat farms in U.S., Canada, Russia), each of which can benefit from seed classification and purity analysis. A system for the general problem of wheat seed purity analysis can be trained up to a certain point and then distributed to the various locations of the agribusiness where further local training can occur. Thus, more rapid global development and more consistent purity analysis across an agribusiness can be achieved.

FIG. 2 illustrates multiple data stores (e.g. 250, 260). The data stores may, for example, replicate data and/or distribute exclusive data. For example, a first data store may be developed that stores classification data for a first set of classifications (e.g. wheat seeds and their weeds). Similarly, a second data store may be developed that stores classification data for a second set of classifications (e.g. grass seeds and their weeds). A trainable seed image analyzer can be trained to perform an initial determination of the type of seed it is processing (e.g. wheat, grass) and then to select the most appropriate data store for acquiring classification data. Again, this makes systems like system 200 more readily applicable to classifying a wider variety of seeds. While two data stores (250, 260) are illustrated, it is to be appreciated that a greater number of data stores may be employed. In one example, the one or more data stores facilitate storing a hierarchical classification based on the FLD. The hierarchical classification may be produced by the system 200 and stored in one or more data stores.

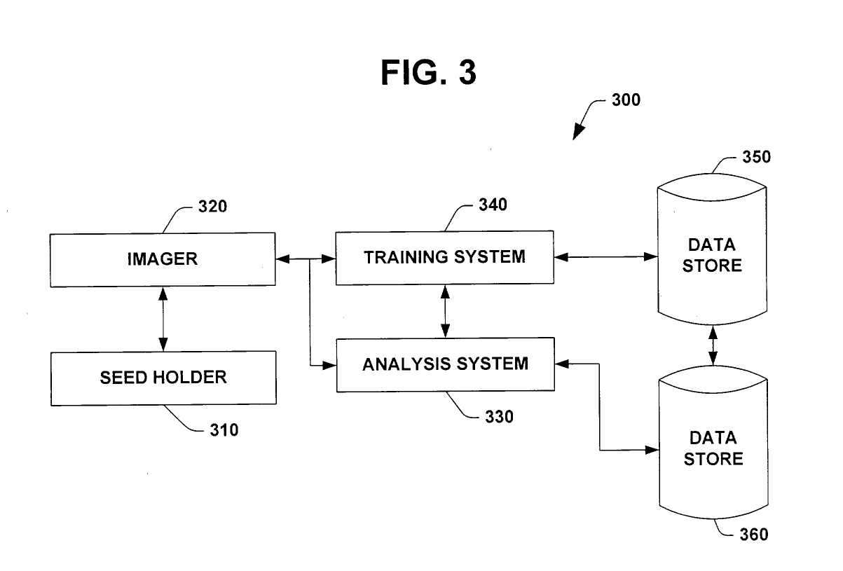

FIG. 3 illustrates an example training and analyzing system 300 where a training system 340 is separate from an analysis system 330. This arrangement facilitates, for example, training up a trainable seed image analyzer and then replicating the trained up portions into an analysis system 330 that is then static and untrainable. This may improve processing time and minimize computing requirements for the analysis system 330. System 300 has access to multiple data stores (e.g., 350, 360). During training, a training system 340 may access a first data store 350 that has a more comprehensive set of seed classifications. After training, the analysis system 330 may receive a trained up analyzer that specializes in certain seed purity analysis and/or sorting processes. Thus, rather than accessing the more comprehensive data store 350, the analysis system 330 may access a more focused data store 360, which can again facilitate reducing processing time, hardware, software, and storage requirements. For example, customs agents may only be concerned with intercepting certain seeds. Thus, a training system 340 may be employed to train up a system for recognizing those seeds. Then, the trained up system may be distributed to a plurality of analysis systems 330 that will interact with a smaller, more focused data store 360.

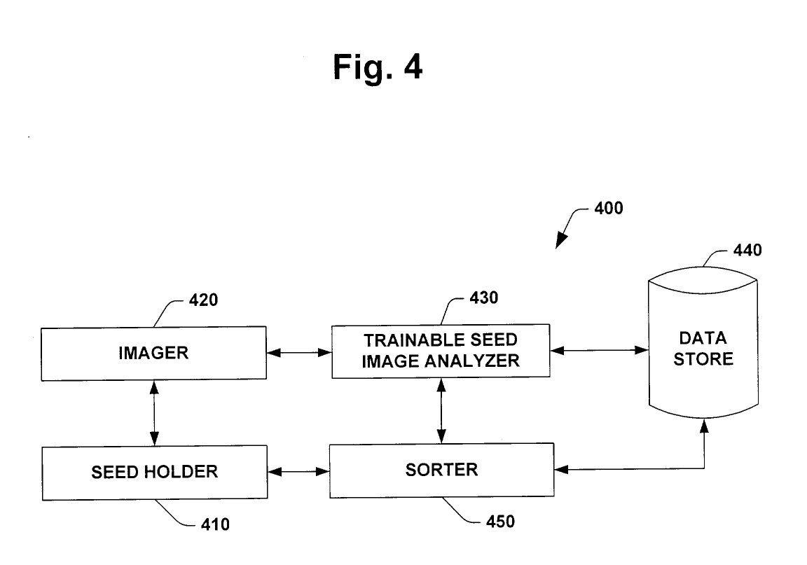

FIG. 4 illustrates an example seed analyzing and sorting system 400. A seed sample in a seed holder 410 can be imaged by the imager 420 and analyzed by the trainable seed image analyzer 430. The trainable seed image analyzer 430 can retrieve classification information from a data store 440 to facilitate making a seed classification. The trainable seed image analyzer 430 can be operably connected to a sorting system 450. The sorting system 450 can thus receive information concerning the seeds in the seed sample in the seed holder 410 and be controlled to sort the seeds. By way of illustration, size information can be transferred to facilitate selecting out seeds within a certain size range. By way of further illustration, seed location information can be transferred to facilitate selecting seeds in certain locations. Those skilled in the art of mechanical, electrical and/or electromechanical sorting will appreciate how such sorting can be performed. While FIG. 4 illustrates the seed holder 410 being separate from the sorting system 450, it is to be appreciated that the seed holder 410 and the seed sorting system 450 can be integrated into a single apparatus. The seed sorting system 450 can therefore be employed to sort seeds based on a classification made by the trainable seed image analyzer 430 and/or based on a purity analysis test performed by the trainable seed image analyzer 430. System 400 may include a GUI (not illustrated) that facilitates performing a seed purity analysis test. For example, a set of data entries representing actions associated with performing a seed purity analysis test (e.g., specifying desired seed, specifying number of FLD dimensions, specifying available sorting time) can be displayed. A signal is received that indicates a choice being made concerning the entries and in response to the signal an operation associated with the operation is initiated.

It will be appreciated that some or all of the processes and methods of the system involve electronic and/or software applications that may be dynamic and flexible processes so that they may be performed in other sequences different than those described herein. It will also be appreciated by one of ordinary skill in the art that elements embodied as software may be implemented using various programming approaches such as machine language, procedural, object oriented, and/or artificial intelligence techniques.

The processing, analyses, and/or other functions described herein may also be implemented by functionally equivalent circuits like a digital signal processor circuit, software controlled microprocessor, or an application specific integrated circuit. Components implemented as software are not limited to any particular programming language. Rather, the description herein provides the information one skilled in the art may use to fabricate circuits or to generate computer software to perform the processing of the system. It will be appreciated that some or all of the functions and/or behaviors of the present system and method may be implemented as logic as defined above.

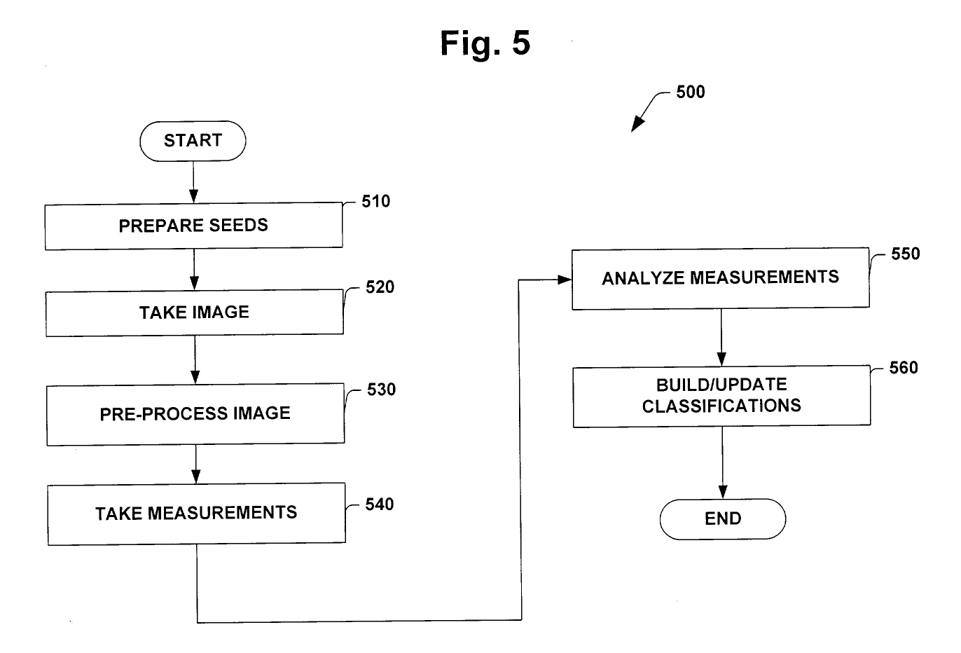

In view of the exemplary systems shown and described herein, example methodologies that are implemented will be better appreciated with reference to the flow diagrams of FIGS. 5 through 8. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Furthermore, additional and/or alternative methodologies can employ additional, not illustrated blocks. In one example, methodologies are implemented as computer executable instructions and/or operations, stored on computer readable media including, but not limited to an ASIC, a compact disc (CD), a digital versatile disk (DVD), a random access memory (RAM), a read only memory (ROM), a programmable read only memory (PROM), an electronically erasable programmable read only memory (EEPROM), a disk, a carrier wave, and a memory stick.

In the flow diagrams, rectangular blocks denote “processing blocks” that may be implemented, for example, in software. Similarly, the diamond shaped blocks denote “decision blocks” or “flow control blocks” that may also be implemented, for example, in software. Alternatively, and/or additionally, the processing and decision blocks can be implemented in functionally equivalent circuits like a digital signal processor (DSP), an ASIC, and the like.

A flow diagram does not depict syntax for any particular programming language, methodology, or style (e.g., procedural, object-oriented). Rather, a flow diagram illustrates functional information one skilled in the art may employ to program software, design circuits, and so on. It is to be appreciated that in some examples, program elements like temporary variables, initialization of loops and variables, routine loops, and so on are not shown. Furthermore, it is to be appreciated that interactive versions of the methods may include additional actions that are not illustrated that facilitate a user interacting with (e.g., controlling, directing, modifying) a method. For example, at some point in a method, an observing user may decide to intervene and complete processing manually.

FIG. 5 illustrates an example method 500 for building a seed analysis database. In one example, a computer implemented method for classifying seeds includes acquiring a digital image of a seed sample, pre-processing the digital image to facilitate acquiring seed measurements, and acquiring measurements from the pre-processed digital image. After the measurements have been acquired, the method can selectively update a seed classification based on the measurements and/or their relationships to other measurements and/or classifications. The method may also selectively update a process that classifies a seed. For example the method may change weights in a neural network. The method may also sort the seed sample. It is to be appreciated that a method may perform one or more or all of these functions under human and/or programmatic control.

Thus, FIG. 5 illustrates a method 500 where, at 510, seeds are prepared to be imaged. For example, the seeds may be arranged and separated to reduce the number of seeds that are touching or that are located in such close proximity that an imager would have difficulty distinguishing two separate seeds. Thus, the preparations before imaging may include separating touching seeds.

The method includes, at 520, acquiring a digital image of the seeds. As noted above, the image may be acquired in a variety of manners. The image acquired at 520 can then be preprocessed at 530. For example, while seeds may have been arranged in a variety of orientations in the seed sample, and thus may have a variety of orientations in the digital image acquired at 520, subsequent measurements may benefit from having the digital images of the seeds manipulated so that the seeds are oriented along their longest axis. Similarly, if certain seeds did not yield an image that meets a certain threshold (e.g., contrast, color, brightness, shape determinability, size), then a portion of the digital image may be thresholded to remove that information. Additionally, and/or alternatively to the separation performed before imaging, the preprocessing of 530 can include programmatically separating images of touching seeds.

At 540, one or more measurements are acquired from the digital image. Example measurements are described above in connection with FIG. 1. Note that the measurements are taken from the digital image, not from the seeds themselves.

At 550, the measurements are analyzed. The analysis may include identifying measurements for which (in)complete data has been received, identifying measurements that are likely to facilitate distinguishing seed classifications, making initial determinations of seed classifications to facilitate database identifying and/or updating, and so on. Based on the measurements taken at 540 and the analysis performed at 550, at 560, one or more databases can be built and/or updated. The databases can store, for example, seed classifications and/or measurement data. As mentioned above, a seed classification may include, for example, an identifier, a set of measurements for the seed classification, subsets of measurements related to distinguishing a seed classification from other seed classifications, algorithm selection information and the like. Furthermore, the seed classifications may be organized, in one example, into a hierarchy.

Thus, while building and/or updating a database that stores seed classifications, the method 500 may create a new classification and/or update an existing classification. Updating a classification can include updating the set of measurements associated with a seed classification (e.g., adding measurements, removing measurements, changing validity ranges). Updating a classification can also include updating a subset of measurements related to distinguishing seed classifications. Thus, new subsets can be created, existing subsets can be updated and/or deleted, and so on. Updating a classification can include adding a measurement to a subset, changing the relevance of a measurement to the classification and so on.

The method 500 can be a trainable method. Thus, how the image is pre-processed, which measurements are taken at 540, how the measurements are analyzed at 550 and/or how the database is manipulated at 560 can be altered on an on-going basis, substantially in real time. For example, as a series of seed images are pre-processed, measured and analyzed, the method 500 may discern that certain measurements have practically no variance and thus may be of limited value in discriminating between seed classifications. Similarly, the method 500 may discern that a certain set of measurements has the ability to distinguish between the seeds in the seed sample. Thus, the method 500 may limit measuring the measurements of limited value and focus on pre-processing that maximizes the likelihood of acquiring accurate measurements for the more relevant measurements. Similarly, the method 500 may reduce analysis processing for the less relevant measurements (e.g., allocate fewer neurons, ignore irrelevant neighbors), and increase analysis processing for the more relevant measures (e.g. calculate a set of FLD projections) for combinations of the more relevant measures. This ability to be trained and to adapt to the seed environment facilitates producing a more general purpose method for classifying seeds.

In one example, the following actions were performed in purity sample image acquisition. Seeds were placed on a solid white sheet of paper in a customized box designed to eliminate outside light. The box had two color, digital scanners attached to its upper lid. The inside of the box was black, and was designed so the scanners were suspended approximately 1 cm above the sheet of paper. Then, the seeds were separated on the paper so that no two seeds touched at any point. The lid to the customized box was then closed. Next, a 200 dots-per-inch (dpi), 32 bit digital color image was obtained and saved in JPEG (Joint Photographic Experts Group) format. While a box with two scanners in the lid is described, it is to be appreciated that other seed holders may be employed. Similarly, while the scanner(s) were suspended approximately one centimeter above the seeds, other orientations and image ranges can be employed. For example, the seeds could sit on the scanner. While a 32 bit, color, 200 dpi image was acquired, other dpi and bit depths can be employed. Similarly, while the image was stored in JPEG format, other formats are contemplated. Likewise, while the seeds were separated manually in this example, the seed separating could be omitted or could be performed by an automated device, for example.

A trainable seed image analyzer benefits from a training phase. In one example, training is restricted to a single seed classification at a time. Thus, a database or database entry for the single classification can be established. In another example, training may relate to two or more seed classifications at a time. Thus the database or database entries for the two or more seed classifications may be built substantially in parallel. Thus, more than one database and/or database entry can be generated by a trainable seed image analyzer.

In one example, the trainable seed image analyzer operates during the training and classification stages in substantially the same manner. The digital color image is presented to the trainable seed image analyzer, which separates foreground pixels from background pixels. A number of techniques known in the art can be employed to perform this operation. A user, and/or the systems and methods described herein can select the algorithm to perform this separating operation. One example algorithm is a thresholding algorithm.

Once the foreground pixels that represents seeds are identified, another algorithm groups contiguous pixels as a single unit and labels the region as a seed. Groups of contiguous pixels may correspond to regions containing more than one seed. Thus, in one example, processing includes identifying the locations in the groups of contiguous pixels that correspond to different seeds. One example process separates objects by identifying points on the contour of the contiguous region that indicate multiple objects. A noise removal algorithm then removes foreground regions that likely do not represent seeds. For example, an area may be too small, too large, of an unacceptable shape or color, and so on. By way of illustration, small pieces of inert matter may appear in the initial digital image but be too small to possibly be seeds, and thus they may be pre-processed out of the seed image. However, a record of their being pre-processed out may be maintained to facilitate producing a purity analysis test report.

Because seeds may be randomly located in the seed holder and thus scanned in this randomly placed manner, the orientation of the images representing seeds varies in the initial digital image. In one example, the areas identified as seeds are rotated so the longest axis of a seed lies along the y-coordinate axis. Automatic alignment can be performed by, for example, detecting an orientation using a statistical method like a moment calculation. A rotation algorithm can then be run on the region containing the image of the seeds to align them vertically as illustrated in FIG. 11.

One example classification technique used by the trainable seed image analyzer is the Fisher Linear Discriminant (FLD) method. Nearest neighbor classification (defined as the class mean having the lowest Euclidean distance from the unknown in the feature space) and a neural network can also be employed. The FLD method is a transformation used on the set of measurements to create a new feature space where more simple classification routines can operate than is conventionally possible in a high dimensional feature space. A set of measurements may define a point in a high dimensional space. Because seeds of a similar species may be similar, the distance between points of the same species within this high dimension space may be small. However, there can be variability in features of the same species (e.g., length ranges 1-5 mm) while different species might share close measurements (e.g., lengths within 1 mm). Some measurements might have such a great variability that they make it more difficult to perform classification within the high dimensional space. The FLD method addresses these issues by creating a transformation that separates classes within the high dimensional space, allowing fewer dimensions and thereby simplifying classification and minimizing the distance between seeds within the same species.

The FLD method involves a projection matrix that maximizes the ratio of between class scatter (variation of each feature between classes) to within class scatter (variation of each feature within classes). The new features created by the projection facilitate discriminating between classes. Thus, rather than attempting to distinguish a first seed associated with a first seed classification from a second seed associated with a second seed classification by examining and/or comparing all available measurements, the example systems and methods described herein may employ subsets of measurements that contribute to an FLD analysis. By way of illustration, an initial examination may determine that a seed sample likely has a high percentage of seed X. The trainable seed image analyzer may then identify one or more subsets of measurements that facilitate distinguishing seed X from other seeds. Locating those subsets can, in one example, be facilitated by analyzing the location of seed X in a seed classification hierarchy. During training, the trainable seed image analyzer may update a seed classification by adding, removing, and/or changing information concerning the measurement subsets and/or relations between seed classifications and distinguishing subsets. The trainable seed image analyzer may propose classification changes and a trainer may confirm or deny the changes. Furthermore, the trainer may augment or diminish the amount of change undertaken in response to the suggested changes. In this way, supervised machine learning and/or human supervised learning can be undertaken to train up a trainable seed image analyzer.

The trainable seed image analyzer can classify a seed using one or more method. One example involves finding the class of the closest projected seed in the new feature space. This method computes the distance from the current seed to other training seeds in the database. The seed is assigned to the class of its closest neighbor. This method is sensitive to seeds in the training set that deviate from the class average. Another method computes the class average of classes within the transformed feature space. The distance from the unknown seed to a class average is computed, and the closest class is chosen as the unknown class.

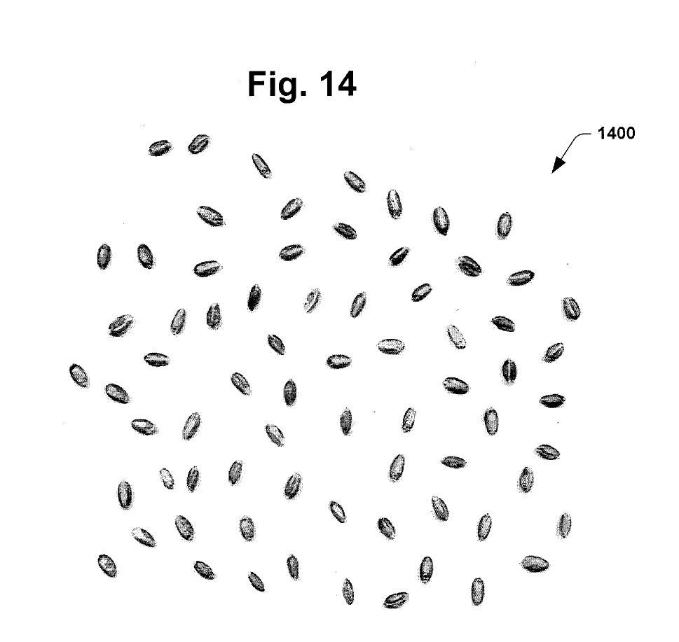

In an example that exercised example systems and methods described herein, to develop sample databases, 21 different seed types were scanned to create training images. Training images had between 100 to 500 individual seeds like those illustrated in FIG. 14. The trainable seed image analyzer analyzed training images and saved the measurements, measurement set descriptions, and/or measurement subset seed classification relation data to a data store. The resulting data store contained at least one entry for the training seeds in the 21 training images. In one example, the data store was a relational database.

Analyzing a subset of the training images and saving the results created more specific databases. These smaller databases were selected to test extremely similar appearing seeds, seeds with several features in common, and seeds with widely varying features. Because of the reduced number of seeds within the feature space, these databases were capable of making finer distinctions and generally contained three seeds, although one test contained six of the smaller seeds in a training set. Thus, it is to be appreciated that example systems and methods described herein for performing purity analysis tests may include apparatus and/or processes that select a database to employ when doing the analysis. The selection may be based, for example, on an initial examination of a seed sample. The initial examination may be automated and/or manual.

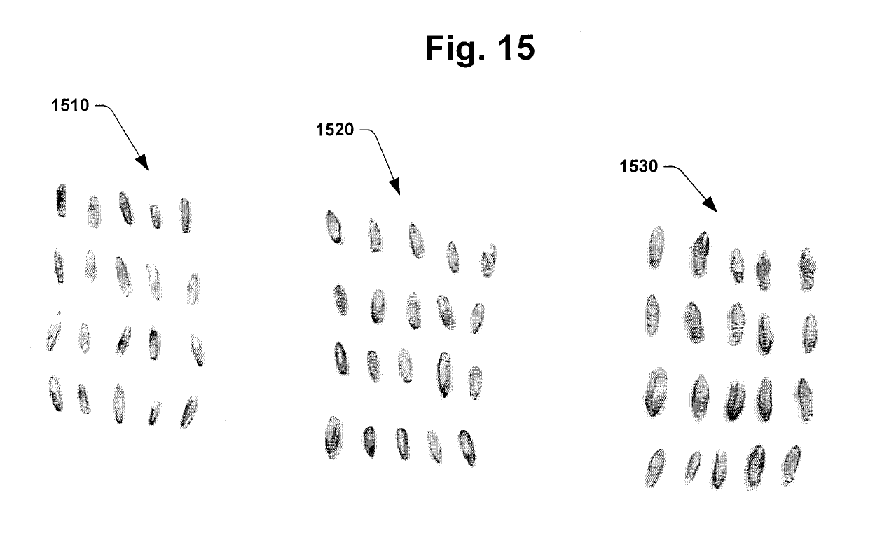

By way of illustration, a test image developed for a database that contained rye (Secale cereale subsp. Cereale), ryegrass (Lolium perenne), and spring triticale (Triticosecale rimpaui) only contained those three seeds. The test image was created by placing 20 samples of each seed to be tested in close proximity to each other so the user operating the trainable seed image analyzer system could determine the class of the seeds and detect errors in classification. Sample test images for this three seed classification example are illustrated in FIG. 15. In another example, the following seeds were used as training data:

| | |
|---|---|
| Alfalfa (Medicago sativa subsp. sativa) | Kale (Brassica oleracea var viridis) |
| Broad leaved dock (Rumex obtusifolius) | Large crabgrass (Digitaria sanguinalis) |
| Crabgrass (Digitaria ischaemum) | Orchardgrass (Dactylis glomerata) |
| Giant foxtail (Setaria faberi) | Poison hemlock (Conium maculatum) |
| Ivy leaf morning glory (Ipomoea hederacea) | Rye (Secale cereale subsp Cereale) |
| Johnsongrass (Sorghum halepense) | Ryegrass (Lolium perenne) |
| Wild carrot (Daucus carota subsp sativus) | Yellow foxtail (Setaria pumila) |
| Sorghum (Sorghum bicolor) | Spring triticale (Triticosecale rimpaui) |
| Turnip (Brassica rapa var rapa) | Velvetleaf (Abutilon theophrasti) |
| Wheat (Triticum aestivum) | White clover (Trifolium repens) |
| Red clover (Trifolium pretense) | |

While 21 seed classifications are listed, it is to be appreciated that the example systems and methods described herein can be employed with a variety of seeds.

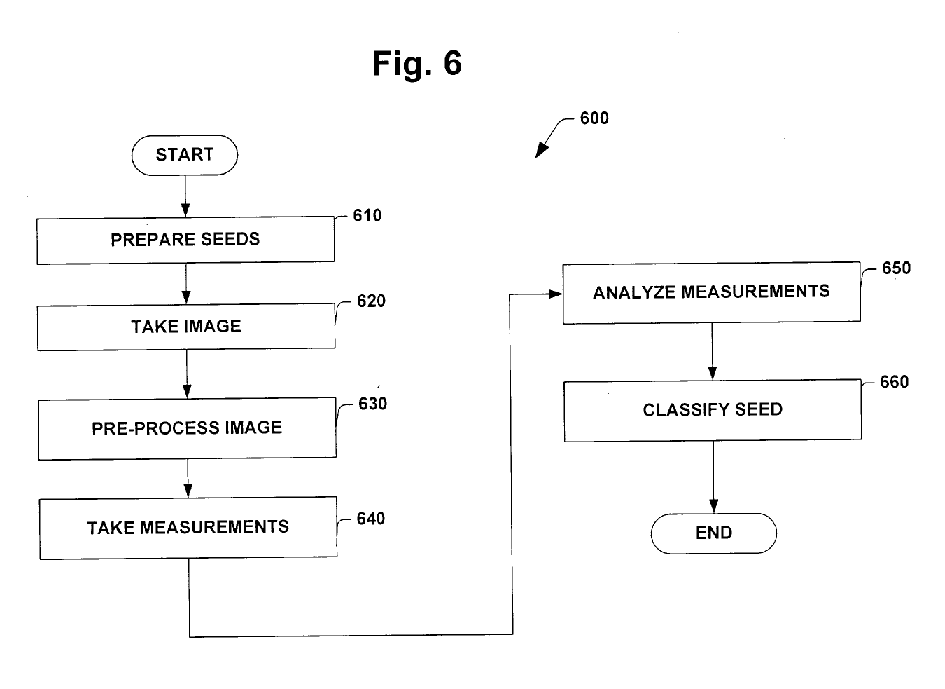

FIG. 6 illustrates an example method 600 for classifying seeds. At 610, seeds are prepared to be imaged by, for example, rearranging the seeds to reduce the number of seeds that are touching or that are located in such close proximity that an imager would have difficulty distinguishing the two separate seeds. At 620, the method 600 includes acquiring a digital image of the seeds. The image acquired at 620 is then preprocessed at 630 (e.g., re-oriented, thresholded). As described above, the pre-preprocessing at 630 can also include, in one example, programmatically separating images of touching seeds into separate images of individual seeds. At 640, one or more measurements are acquired from the digital image.

Example measurements are described above in connection with FIG. 1. At 650, the measurements are analyzed. The analysis may include identifying measurements for which data has been provided where the measurements will facilitate classifying a seed, performing one or more FLD projections and determinations, performing a neural network operation, performing a nearest neighbor calculation, and so on. Based on the measurements taken at 640 and the analysis performed at 650, and after referring to a database like that developed by method 500, at 660, a seed may be classified as belonging to a seed classification. In one example, a confidence level may be attached to the seed classification. In one example, the confidence level may be used by the system to signal a human operator to perform additional and/or alternative manual sorting and/or classifying. Thus, the confidence level might be included with process results that facilitate a human operator modifying classification results.

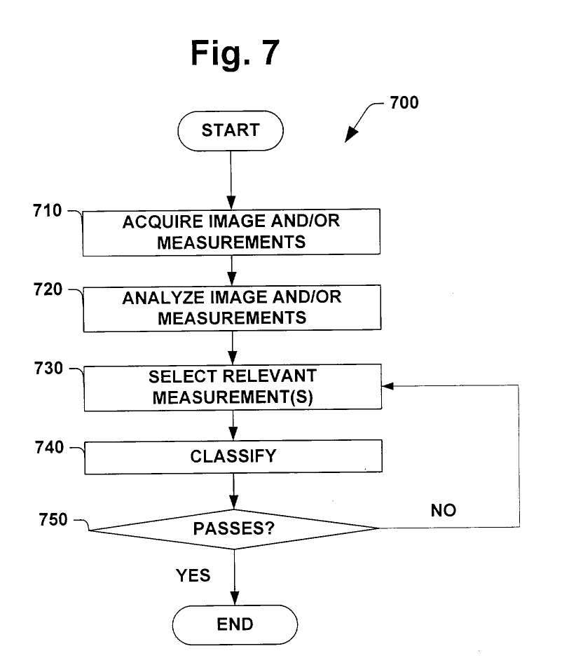

FIG. 7 illustrates an example method 700 for classifying seeds. At 710, one or more images and/or measurements associated with the images are acquired. For example, a scanner could produce a digital image that is then processed using computer imaging techniques to take measurements related to the items represented in the digital image (e.g., seeds). At 720, the image and/or measurements are analyzed. For example, FLD analysis, neural network analysis, nearest neighbor analysis and other processing described herein could be performed when analyzing the image and/or measurements.

At 730, the method 700 selects a candidate measurement or set of measurements to evaluate with respect to how well, if at all, it partitions the feature space developed from the image and/or measurement analysis and thus whether it/they can be employed to classify seeds. At 740, a seed classification is made based on the candidate measurement(s). At 750, a determination is made concerning the correctness of the measurement. If the classification satisfies a determiner, then the method 700 has been trained up to the point where it can make a seed classification. But if the determination at 750 is NO, then processing returns to 730 where one or more different measurements and/or sets of measurements are selected to attempt to partition the data space. The 730-750 loop can be repeated until a desired set of measurements is found or until a retry number of attempts has been exceeded. Additionally, and/or alternatively, the 730-750 loop can continue until a supervisor (e.g., human, machine learning system), determines that the looping should cease. The entity making the determination at 750 can be an automated trainer (e.g. computer component programmed for supervising machine learning) and/or a human.

Method 700 may also, at 730, select a classification technique from various available classification techniques to apply to the measurements. For example, the method 700 may select an FLD classification technique based on the dimensionality of the feature space or the method 700 may select a neural network technique based on a perceived time processing constraint. Once again the 730-750 loop may be repeated to try various classification techniques to make a seed classification. Thus, the method 700 can be trained up not only to select measurements that are relevant to making a seed classification, but also the type of classification technique to apply to those measurements. This facilitates applying the method 700 to a wider variety of seeds than is conventionally possible.

Once measurements and/or classification techniques have been learned, the method 700 may store the classifications, measurements, and/or classification techniques in a data store to facilitate subsequent seed classification that benefits from training up method 700. It is to be appreciated that a seed classification that employs a trainable seed analyzer trained up using method 700 may therefore select one or more classification algorithms to employ in classifying a seed, determine the order in which the classification algorithms are to be applied, and determine the order in which seeds will be distinguished from other seeds. Furthermore, in a sorting application, the method 700 may selectively sort out eliminated seeds and repeat the select/removal process until a desired classification confidence level has been reached.

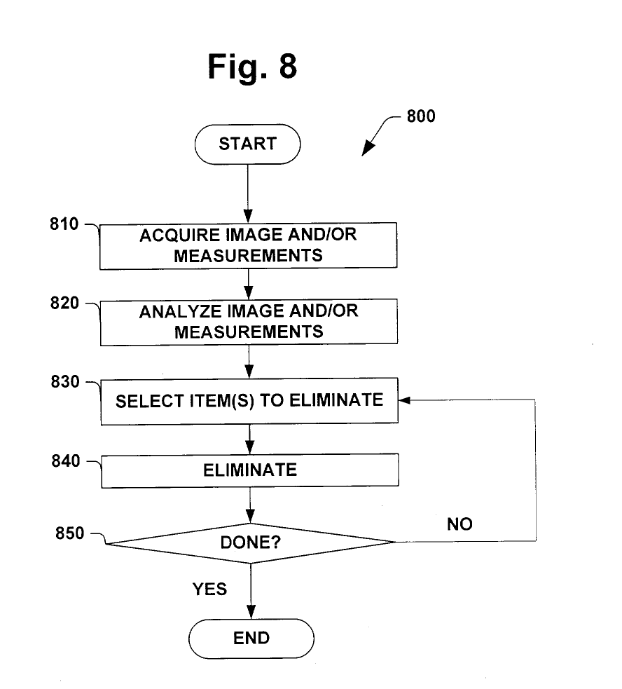

FIG. 8 illustrates an example method 800 for sorting seeds. At 810, one or more images and/or measurements associated with the images are acquired. For example, a scanner could produce a digital image that is then processed using computer imaging techniques to take measurements related to the items represented in the digital image (e.g., seeds). At 820, the image and/or measurements are analyzed. For example, the FLD analysis, neural network analysis, nearest neighbor analysis and other processing described herein could be performed when analyzing the image and/or measurements.

At 830, based on the measurements from 810 and/or the analysis at 820, an item, set of items, and/or class of items are selected to be eliminated from the seed sample. For example, a seed sample may be identified as having ten potential components. After a first measure/analyze cycle, it may be determined that all items smaller than a certain size can be eliminated from the sample. Thus, at 830, items with a certain size would be selected to be eliminated from the seed sample. At 840, the items would be eliminated. Those skilled in the art of mechanical, electrical, electronic, and/or electromechanical sorting will appreciate that various techniques (e.g. filtering, gravity feeds, weight suction, location suction) can be employed to remove seeds from the seed sample.

At 850, a determination is made concerning whether the seed sample has been sorted to a desired classification confidence level. If the determination at 850 is YES, then processing can conclude, otherwise processing can return to 830. The method 800 thus facilitates sorting seed samples by partitioning an input seed sample into two or more output seed samples, where the output seed samples contain subsets of the input sample and where the subsets contain mutually exclusive seed classifications to within a desired tolerance. By way of illustration, an input sample may have five types of seeds. The input sample may initially be sorted into two samples, one with all seeds larger than a certain size and one with all seeds smaller than a certain size. The larger sized sample may then be sorted into seeds that are darker than a certain shade of red that have two or more spiny protuberances and other seeds. Thus, after two passes, the input sample will have been partitioned and then partitioned again until an output seed sample can be produced that has a desired percentage of large red seeds with two or more spiny protuberances.

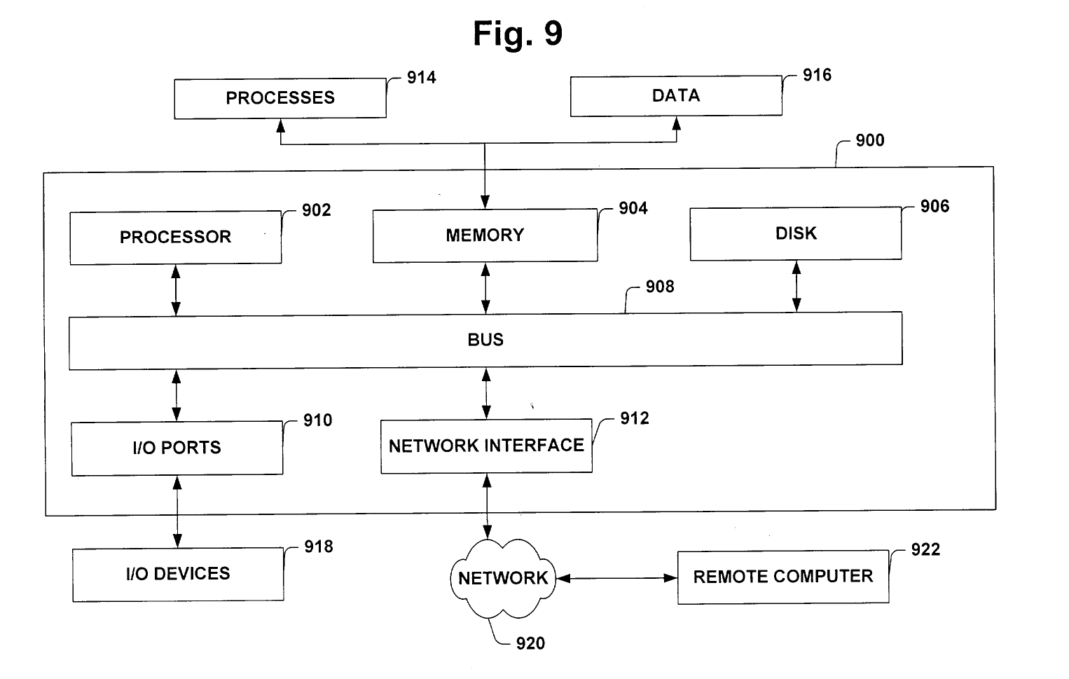

FIG. 9 illustrates a computer 900 that includes a processor 902, a memory 904, a disk 906, input/output ports 910, and a network interface 912 operably connected by a bus 908. Executable components of the systems described herein may be located on a computer like computer 900. Similarly, computer executable methods described herein may be performed on a computer like computer 900. Computer 900 is one example of a computer component.

It is to be appreciated that other computers may also be employed with the systems and methods described herein. The processor 902 can be a variety of various processors including dual microprocessor and other multi-processor architectures. The memory 904 can include volatile memory and/or non-volatile memory. The non-volatile memory can include, but is not limited to, read only memory (ROM), programmable read only memory (PROM), electrically programmable read only memory (EPROM), electrically erasable programmable read only memory (EEPROM), and the like. Volatile memory can include, for example, random access memory (RAM), synchronous RAM (SRAM), dynamic RAM (DRAM), synchronous DRAM (SDRAM), double data rate SDRAM (DDR SDRAM), and direct RAM bus RAM (DRRAM). The disk 906 can include, but is not limited to, devices like a magnetic disk drive, a floppy disk drive, a tape drive, a Zip drive, a flash memory card, and/or a memory stick. Furthermore, the disk 906 can include optical drives like, compact disk ROM (CD-ROM), a CD recordable drive (CD-R drive), a CD rewriteable drive (CD-RW drive) and/or a digital versatile ROM drive (DVD ROM). The memory 904 can store processes 914 and/or data 916, for example. The disk 906 and/or memory 904 can store an operating system that controls and allocates resources of the computer 900.

The bus 908 can be a single internal bus interconnect architecture and/or other bus architectures. The bus 908 can be of a variety of types including, but not limited to, a memory bus or memory controller, a peripheral bus or external bus, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

The computer 900 interacts with input/output devices 918 via input/output ports 910. Input/output devices 918 can include, but are not limited to, a scanner, a keyboard, a microphone, a pointing and selection device, cameras, video cards, displays, and the like. The input/output ports 910 can include but are not limited to, serial ports, parallel ports, SCSI ports, and USB ports.

The computer 900 can operate in a network environment and thus is connected to a network 920 by a network interface 912. Through the network 920, the computer 900 may be logically connected to a remote computer 922. The network 920 can include, but is not limited to, local area networks (LAN), wide area networks (WAN), and other networks. The network interface 912 can connect to local area network technologies including, but not limited to, fiber distributed data interface (FDDI), copper distributed data interface (CDDI), ethernet/IEEE 802.3, token ring/IEEE 802.5, and the like. Similarly, the network interface 912 can connect to wide area network technologies including, but not limited to, point to point links, and circuit switching networks like integrated services digital networks (ISDN), packet switching networks, and digital subscriber lines (DSL).

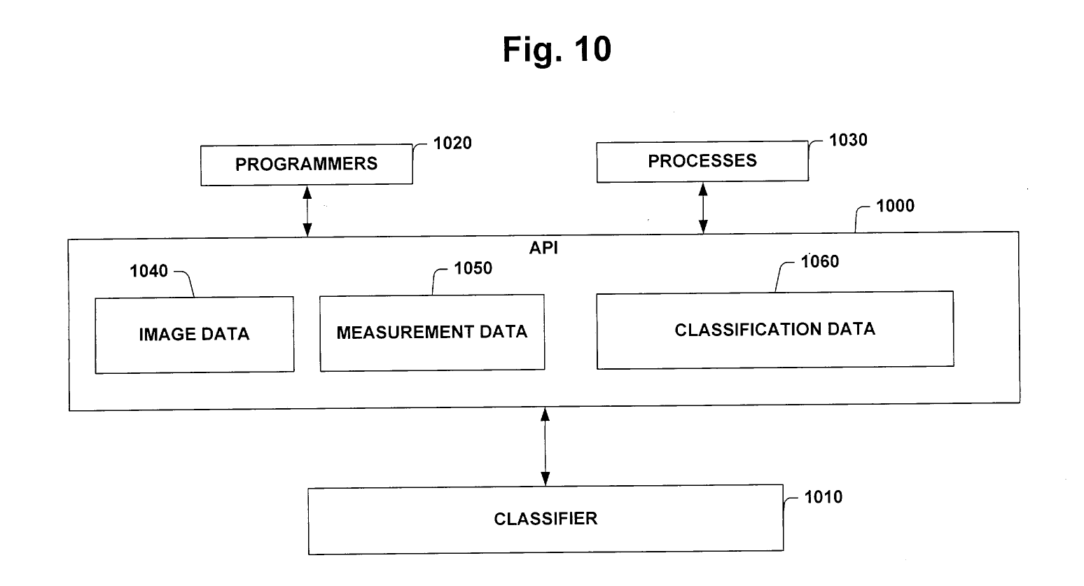

Referring now to FIG. 10, an application programming interface (API) 1000 is illustrated providing access to a system 1010 that includes a seed analyzing and/or sorting classifier. The API 1000 can be employed, for example, by programmers 1020 and/or processes 1030 to gain access to processing performed by the system 1010. For example, a programmer 1020 can write a program to access a seed classifier 1010 (e.g., to invoke its operation, to monitor its operation, to access its functionality) where writing a program is facilitated by the presence of the API 1000. Thus, rather than the programmer 1010 having to understand the internals of the seed classifier, the programmer's task is simplified by merely having to learn the interface to the seed classifier. This facilitates encapsulating the functionality of the seed classifier while exposing that functionality.

Similarly, the API 1000 can be employed to provide data values to the system 1010 and/or retrieve data values from the system 1010. For example, a process 1030 that retrieves a seed classification can provide image data and/or measurement data to the seed classifier 1010 via the API 1000 by, for example, using a call provided in the API 1000. Thus, in one example of the API 1000, a set of application program interfaces can be stored on a computer-readable medium. The interfaces can be executed by a computer component to gain access to a seed classifier 1010. Interfaces can include, but are not limited to, a first interface 1040 that facilitates communicating an image data associated with one or more seeds in a sample, a second interface 1050 that facilitates communicating a measurement data associated with one or more seeds in the sample, and a third interface 1060 that facilitates communicating a classification data derived from the image data and/or the measurement data.

FIG. 11 illustrates example digital image pre-processing. Image 1100 may be, for example, an initial digital image acquired from a digital scanner. Image 1110 may represent the image 1100 transformed by an initial pre-processing like thresholding. Image 1120 represents individual images, in both initial and thresholded representations, cropped from the digital image into smaller images. The pre-processing may have included separating digital images of touching seeds into digital images of individual seeds as illustrated in 1120. Image 1130 illustrates these cropped images rotated to be oriented along their longest axis. This type of digital pre-processing facilitates acquiring measurements that are then employed in classifying seeds. After training up a trainable seed image analyzer, certain image pre-processing may be abandoned while other image pre-processing may be performed more frequently and/or more intensely. For example, if the set of measurements that distinguish certain seed classifications relies primarily on color, then the rotation may not be undertaken because the color is unaffected by rotation. Similarly, if the set of measurements that distinguish certain seed classifications are independent of color, then color pre-processing may not be undertaken. This facilitates faster run time processing in a trained up trainable seed image analyzer.

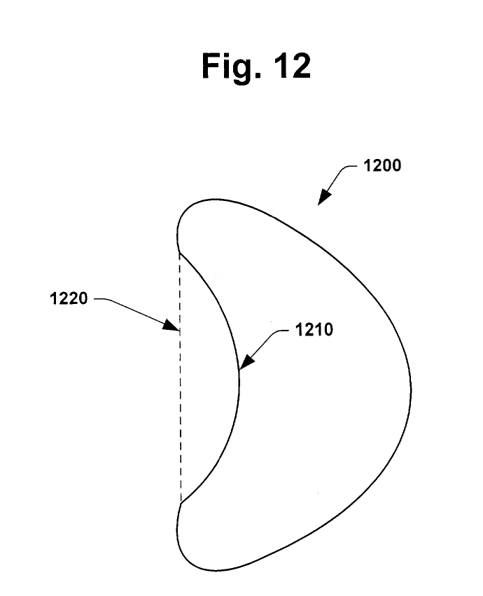

One measurement that can be further examined concerns the “convex hull” measurement. FIG. 12 illustrates a seed 1200 that has a concave shape. The concave shape is created by the concavity 1210. By drawing line 1220, the “convex hull” shape of seed 1200 can be produced. The convex hull is defined as the smallest convex set that contains a given set. Thus, a straight line connecting any two points in a convex set lies entirely within that set. The convex hull shape, size, area, and perimeter, and ratios associated therewith, may be employed in classifying seeds. For example, the convex hull of substantially round seeds will be substantially equivalent to the actual shape measurements of the round seeds while the convex hull of star shaped seeds will be substantially different from the actual shape measurements.

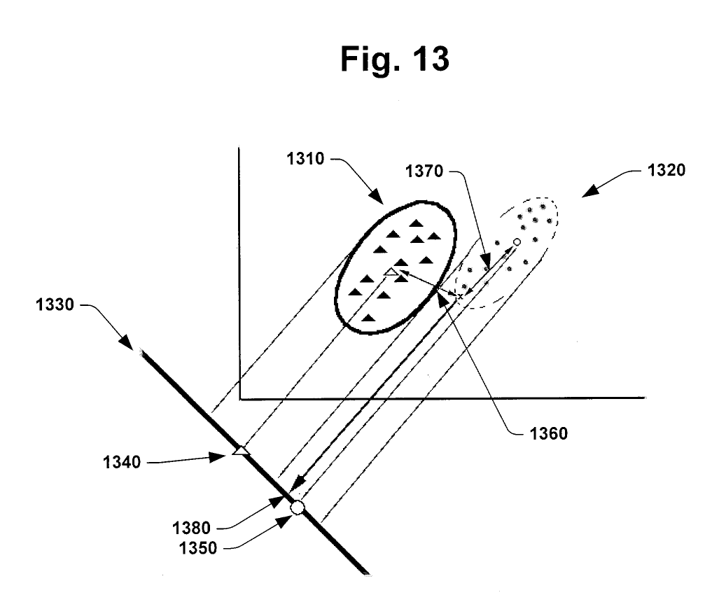

FIG. 13 illustrates the concept behind a Fisher Linear Discriminant projection. In FIG. 13, assume the x axis of the graph represents a seed width measurement and the y axis of the graph represents seed length. Cluster 1310 represents samples of a first seed while cluster 1320 represents samples of a second seed. An example seed X, located in the lower left of cluster 1320, falls within the classification represented by cluster 1320. However, the distance 1360 of sample X from the center of cluster 1310 and the distance 1370 from the center of cluster 1320 are very similar, and thus some classification techniques (e.g., nearest neighbor without FLD) may misclassify sample X.

Using FLD, a hyperplane 1330 is determined on which the initial observations are projected so that the variance within each seed class is minimized while the between-class scatter is maximized. As a result, the projected centers of each class are well separated from each other. For example, projected center 1340 is well separated from projected center 1350. Furthermore, location 1380, which corresponds to the FLD projection of sample X, is closer to projected center 1350 than 1340, which is the correct classification.

FIG. 14 illustrates an example digital image of seeds before pre-processing like rotation. FIG. 15 illustrates digital images of three types of related seeds after rotational pre-processing. Those skilled in the art of computer imaging will appreciate that other pre-processing can be employed to facilitate acquiring measurements and extracting features from the digital images.

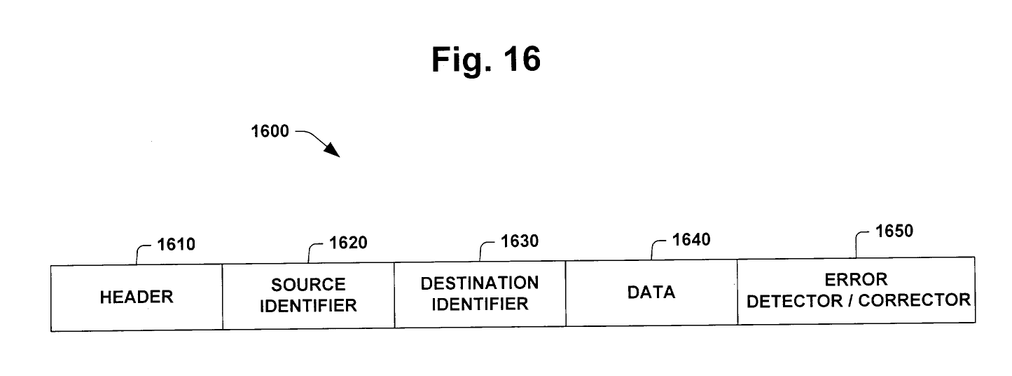

Referring now to FIG. 16, information can be transmitted between various computer components associated with seed imaging, analysis and/or sorting as described herein via a data packet 1600. An exemplary data packet 1600 is shown. The data packet 1600 includes a header field 1610 that includes information like the length and type of packet. A source identifier 1620 follows the header field 1610 and includes, for example, an address of the computer component from which the packet 1600 originated. Following the source identifier 1620, the packet 1600 includes a destination identifier 1630 that holds, for example, an address of the computer component to which the packet 1600 is ultimately destined. Source and destination identifiers can be, for example, globally unique identifiers (guids), URLS (uniform resource locators), path names, and the like. The data field 1640 in the packet 1600 includes various information intended for the receiving computer component. The data packet 1600 ends with an error detecting and/or correcting 1650 field whereby a computer component can determine if it has properly received the packet 1600. While six fields are illustrated in the data packet 1600, it is to be appreciated that a greater and/or lesser number of fields can be present in data packets.

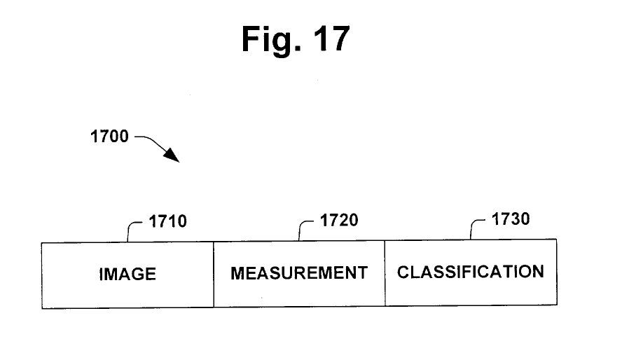

FIG. 17 is a schematic illustration of sub-fields 1700 within the data field 1640 (FIG. 16). The sub-fields 1700 discussed are merely exemplary and it is to be appreciated that a greater and/or lesser number of sub-fields could be employed with various types of data germane to seed imaging, analysis and/or sorting as described herein. The sub-fields 1700 include a field 1710 that includes, for example, information concerning an image of seeds. The information may include, but is not limited to, an image address, an image, an image file format, an image encoding, an image encryption data, and so on. The sub-fields 1700 may also include a measurement field 1720 that includes, for example, information concerning measurement of seeds identified in or related to the image data 1710. The measurement data 1720 may include, but is not limited to, measurement data concerning width, height, area, perimeter, area to perimeter ratio, depth, width to height to depth ratio, color, hue, saturation, intensity, width to height ratio, convex hull area and perimeter, extent fill, texture, depth, and so on. The sub-fields 1700 may also include a classification field 1730 that includes, for example, information concerning a class to which a seed belongs and/or a candidate class to which a seed may be assigned. The classification data 1730 may include, but is not limited to, a classification name, a classification number, a classification location, a classification certainty, and so on.

The systems, methods, and objects described herein may be stored, for example, on a computer readable media. Media can include, but are not limited to, an ASIC, a CD, a DVD, a RAM, a ROM, a PROM, a disk, a carrier wave, a memory stick, and the like. Thus, an example computer readable medium can store computer executable instructions for the methods claimed below and their equivalents.

What has been described above includes several examples. It is, of course, not possible to describe every conceivable combination of components or methodologies for purposes of describing the systems, methods, computer readable media and so on employed in analyzing, classifying and/or sorting seeds. However, one of ordinary skill in the art may recognize that further combinations and permutations are possible. Accordingly, this application is intended to embrace alterations, modifications, and variations that fall within the scope of the appended claims. Furthermore, the preceding description is not meant to limit the scope of the invention. Rather, the scope of the invention is to be determined only by the appended claims and their equivalents.

While the systems, methods and so on herein have been illustrated by describing examples, and while the examples have been described in considerable detail, it is not the intention of the applicants to restrict or in any way limit the scope of the appended claims to such detail. Additional advantages and modifications will be readily apparent to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

What is claimed is:

1. A computer implemented system for classifying a seed, comprising:
a data store for storing one or more seed classifications;
a trainable seed image analyzer that receives a digital seed image and that can be selectively controlled to:
(a) relate the digital seed image to a seed classification;
(b) update a seed classification; and
(c) perform a purity analysis test; and
a trainer for training the trainable seed image analyzer.

2. The system of claim 1, where the trainable seed image analyzer acquires one or more measurements from the digital seed image.

3. The system of claim 1, where the measurements are one or more of the width, height, width to height ratio, depth, width to height to depth ratio, area, perimeter, area to perimeter ratio, color, hue, saturation, intensity, extent fill, hull convexity, and texture.

4. The system of claim 1, where the measurements are the width, height, width to height ratio, depth, width to height to depth ratio, area, perimeter, area to perimeter ratio, color, hue, saturation, intensity, extent fill, hull convexity, and texture.

5. The system of claim 1, where the trainable seed image analyzer includes a computer component for performing a neural network processing that relates the digital seed image to a seed classification.

6. The system of claim 1, where the trainable seed image analyzer includes a computer component for performing a Fisher Linear Discriminant projection processing that relates the digital seed image to a seed classification.

7. The system of claim 1, where the trainable seed image analyzer includes a computer component for performing nearest neighbor classification that relates the digital seed image to a seed classification.

8. The system of claim 1, where the trainable seed image analyzer includes one or more computer components for neural network processing, Fisher Linear Discriminant projection processing, and nearest neighbor classification processing that relate the digital seed image to a seed classification.

9. The system of claim 1, where the trainable seed image analyzer includes computer components for neural network processing, Fisher Linear Discriminant processing, and nearest neighbor classification processing that can be programmatically selected to relate the digital seed image to a seed classification.

10. The system of claim 1, where a seed classification comprises:
an identifier;
a set of measurements; and
one or more subsets of measurements related to distinguishing a digital seed image associated with one seed classification from one or more other seed classifications.

11. The system of claim 10, where the seed classification comprises:
a classification algorithm identifier.

12. The system of claim 10, where the trainable seed image analyzer updates a seed classification by updating the set of measurements for the seed classification.

13. The system of claim 10, where the trainable image analyzer updates a seed classification by updating the one or more subsets of measurements related to distinguishing a digital seed image associated with one seed classification from one or more other seed classifications.

14. The system of claim 10, where the trainable seed image analyzer relates the digital seed image to a seed classification based on one or more of the measurements.

15. The system of claim 1, comprising an imager for acquiring a digital seed image.

16. The system of claim 15, where the imager is a color, digital scanner.

17. The system of claim 15, where the imager comprises one or more of, a color digital scanner, a digital still camera, and a digital video camera.

18. The system of claim 1, where the data store stores values for one or more digital seed image measurements.

19. The system of claim 15, where the imager, the seed measurer, the data store, the trainable seed image analyzer, and the trainer are physically located in one location.

20. The system of claim 15, where one or more of the imager, the seed measurer, the data store, the trainable seed image analyzer, and the trainer are physically located in one or more distributed locations.

21. The system of claim 15, comprising:
a seed holder for holding one or more seeds from which the imager acquires the digital seed image; and
a seed sorter for sorting the one or more seeds based on trainable seed image analyzer processing.

22. The system of claim 15 comprising a seed holder.

23. The system of claim 22, where the seed holder is a box whose insides can be adapted to facilitate producing high contrast digital images.

24. The system of claim 23, where the seed holder can be lined with one or more sheets of paper that vary in color or texture.

25. The system of claim 23, where the inside of the box is formed from one or more panels that can change color under programmatic control.

26. The system of claim 22, where the inside of the seed holder can be selectively illuminated with one or more different colors of light under programmatic control.

27. A computer readable medium storing computer executable components of the system of claim 1.

28. A computer readable medium storing computer executable components of the system of claim 21.

29. A computer implemented method for classifying seeds, comprising:
acquiring a digital image of a seed sample;
pre-processing the digital image to produce one or more pre-processed digital images that facilitate taking seed measurements;
acquiring one or more seed measurements from the pre-processed digital images; and
selectively performing one or more of:
(a) selectively updating a seed classification;
(b) selectively updating a process that classifies a seed; and
(c) sorting the seed sample.

30. The method of claim 29, comprising, preparing a seed sample to be imaged by separating the seeds to reduce the number of seeds that are touching.

31. The method of claim 29, where pre-processing the digital image comprises one or more of, thresholding out selected items in the digital image, forming one or more pre-processed digital images that hold one representation of a seed, separating an image of two or more touching seeds into two or more independent seed images, and rotating individual seed representations within a pre-processed digital image so that they are aligned along their longest axis.

32. The method of claim 29, where the measurements are one or more of the width, height, width to height ratio, depth, width to height to depth ratio, area, perimeter, area to perimeter ratio, color, hue, saturation, intensity, extent fill, hull convexity, and texture.

33. The method of claim 29, where the measurements are the width, height, width to height ratio, depth, width to height to depth ratio, area, perimeter, area to perimeter ratio, color, hue, saturation, intensity, extent fill, hull convexity, and texture.

34. The method of claim 29, where a seed classification comprises:
an identifier;
a set of measurements for the seed classification; and
one or more subsets of measurements related to distinguishing seeds in a different classification.

35. The method of claim 34, where selectively updating a seed classification comprises updating the set of measurements associated with a seed classification.

36. The method of claim 34, where selectively updating a seed classification comprises updating one or more subsets of measurements related to distinguishing seeds in a different classifications.

37. The method of claim 29, where selectively updating a process that classifies a seed comprises altering the relevance of one or more measurements employed in classifying a seed.

38. The method of claim 29, where selectively updating a process that classifies a seed comprises altering the choice of measurements employed in classifying a seed.

39. The method of claim 29, where selectively updating a process that classifies a seed comprises:
selecting one or more classification algorithms to employ in classifying a seed;
determining the order in which the one or more classification algorithms will be applied;
determining the order in which a seed will be distinguished from other seeds;
selectively sorting out an eliminated seed; and
repetitively classifying a seed with respect to one or more remaining seeds until a desired classification confidence level has been reached.

40. The method of claim 29 where sorting the seed sample comprises automatically partitioning an input seed sample into two or more output seed samples, where the output seed samples contain subsets of the input sample, where the subsets contain substantially mutually exclusive seed classifications, to within a desired tolerance.

41. The method of claim 29, comprising signaling an operator to perform additional manual sorting.

42. The method of claim 29, comprising signaling an operator to perform additional manual seed classification.

43. A computer readable medium storing computer executable instructions operable to perform computer executable portions of the method of claim 29.

44. A computer implemented method for generating a seed classification data, comprising:
acquiring one or more digital seed images;
acquiring one or more measurements related to the digital seed images;
selecting one or more of the measurements to attempt to distinguish a first seed classification from one or more second seed classifications;
determining whether the selected measurements distinguish a first seed in the first seed classification from one or more second seeds in the one or more second seed. classifications with a desired error rate;
selectively repeating the selecting and determining until a set of measurements is acquired that facilitates distinguishing the first seed classification from one or more second seed classifications to the desired error rate or until a retry number of attempts to select the one or more set of measurements have been made; and
if a set of measurements that facilitates distinguishing a first seed classification from one or more second seed classifications to the desired error rate is acquired, then storing the sets of measurements for use by a trainable seed image analyzer.

45. The method of claim 44, where the digital seed images are acquired from a color, digital scanner.

46. The method of claim 44, where the measurements are one or more of the width, height, width to height ratio, depth, width to height to depth ratio, area, perimeter, area to perimeter ratio, color, hue, saturation, intensity, extent fill, hull convexity, and texture.

47. The method of claim 44, where the measurements are the width, height, width to height ratio, depth, width to height to depth ratio, area, perimeter, area to perimeter ratio, color, hue, saturation, intensity, extent fill, hull convexity, and texture.

48. A system for determining the composition of a seed sample, comprising:
means for creating a seed classification;
means for acquiring a digital image of a seed sample, where the seed sample comprises one or more seeds related to one or more seed classifications;
means for acquiring one or more measurements of the one or more seeds from the digital image;
means for creating one or more relationships between one or more measurements for one or more seed classifications that facilitate distinguishing a seed associated with a first seed classification from a seed associated with one or more second seed classifications;
means for determining a relationship between a seed and a classification; and
means for determining the composition of a seed sample based on a set of relationships determined between the seeds in the seed sample and one or more classifications.

49. A set of application programming interfaces embodied on a computer readable medium for execution by a computer component in conjunction with distinguishing seeds, comprising:
a first interface for communicating an image data;
a second interface for communicating a measurement data, where the measurement data relates to items in the image data; and
a third interface for communicating a classification data, where the classification data relates an item in the image data to a seed classification based, at least in part, on the measurement data.

50. In a computer system having a graphical user interface comprising a display and a selection device, a method of providing and selecting from a set of data entries on the display, the method comprising:
retrieving a set of data entries, each of the data entries representing an action associated with training a trainable image analyzer, where the trainable image analyzer relates a seed image to a seed classification, updates a seed classification or performs a seed purity analysis test;
displaying the set of entries on the display;
receiving a data entry selection signal indicative of the selection device selecting a selected data entry; and
in response to the data entry selection signal, initiating an operation associated with the selected data entry.

51. In a computer system having a graphical user interface comprising a display and a selection device, a method of providing and selecting from a set of data entries on the display, the method comprising:
retrieving a set of data entries, each of the data entries representing an action associated with performing a seed purity analysis test;
displaying the set of entries on the display;
receiving a data entry selection signal indicative of the selection device selecting a selected data entry; and
in response to the data entry selection signal, initiating an operation associated with the selected data entry.

52. A computer data signal embodied in a transmission medium, comprising:
a first set of executable instructions for acquiring an image of a seed;
a second set of executable instructions for acquiring a measurement of the seed from the image of the seed; and
a third set of executable instructions for classifying the seed based on the measurement.

53. The computer data signal embodied in the transmission medium of claim 50, comprising:
a fourth set of executable instructions for sorting one or more seeds based on classifying a seed.

54. A data packet for transmitting a seed purity analysis data, comprising:
a first field that stores an image data associated with a seed;
a second field that stores a measurement data extracted from a seed information in the image data; and
a third field that stores a classification data derived from the measurement data.
